(19) United States
(12) Patent Application Publication
(10) Pub. No.: US 2006/0102873 A1
(43) Pub. Date: May 18, 2006

(54) Getter

(76) Inventors: John Leonello Casci, Cleveland (GB); Stephen John Catchpole, Cleveland (GB)

Correspondence Address: RATNERPRESTIA, P O BOX 980, VALLEY FORGE, PA, 19482-0980, US

(21) Appl. No.: 10/522,216

(22) PCT Filed: Jul. 11, 2003
(86) PCT No.: PCT/GB03/03034

§ 371 Date: Sep. 19, 2005

(30) Foreign Application Priority Data
Jul. 24, 2002 (GB) 02171437

(51) Int. Cl. H01J 7/18

(52) U.S. Cl. 252/181.1

(57) ABSTRACT

An oxygen getter for use in electronic apparatus and the like comprises a readily oxidisable metal or metal compound such as copper, cobalt or nickel supported on a solid support such as alumina, silica, titania, zirconia or a zeolite.

This invention relates to getters and in particular to getters for electrical and electronic applications. Getters are often used within a sealed enclosure forming part of, or a housing for, the electrical or electronic device, to remove unwanted materials from the atmosphere within the enclosure.

It has been proposed in U.S. Pat. No. 5,696,785 to provide, as a getter for a high power laser enclosure, a composition consisting of two types of adsorbent bound with an inorganic binder. The first type of adsorbent, therein termed a “W” component, was a material having a pore or channel size suitable for immobilising water, selected from a list of certain natural and synthetic zeolitic materials, including zeolites 3A, 4A and 5A. The other adsorbent, therein termed a “O” component, was a material having a pore size suitable for immobilising the larger organic molecules and was selected from a list of materials, some of which were natural and synthetic zeolitic materials having pore sizes at or above about 0.6 nm.

WO-A-02/43098 describes a getter for use in a sealed enclosure, in the form of a porous body formed from particles of a FAU zeolite having a silica to alumina molar ratio below 10 and particles of a high silica to alumina molar ratio zeolite, having a silica to alumina molar ratio of at least 20, bound together with an inorganic binder.

The known getters are useful to remove water and organic molecules from an atmosphere. However other species such as oxygen may also cause damage to electronic components and speciality materials. For example, compounds susceptible to oxidation may be damaged by the presence of oxygen in their surrounding atmosphere. This is particularly true of some metallic or polymeric materials which may degrade in an O₂-rich atmosphere, leading to degradation of their physical properties. When such materials have been selected specifically to provide such properties, any change in physical properties may lead to harmful effects on the system in which it is used.

We have now found a getter composition which is effective for the removal of O₂ from a surrounding atmosphere.

According to the invention, we provide a getter for use in a sealed enclosure comprising a readily oxidisable metal or metal compound supported on a solid support.

By readily oxidisable metal we mean that the metal is capable of being oxidised by the free O₂ present in the atmosphere under the conditions found in the enclosure (normally ambient temperature and pressure). The metal is preferably selected from nickel, cobalt and copper or mixtures thereof. The metal may be present as elemental metal, forming metal oxides as O₂ is absorbed from the atmosphere. The fixing of the O₂ as the oxide reduces the O₂ concentration in the enclosure. Therefore some of the metal is present in the form of metal oxide when the getter is in use. The metal may also be present as a metal compound in which the metal is, initially in a first oxidation state, and which forms a second compound in which the metal is in a second, higher, oxidation state as O₂ is absorbed during use. Therefore the getter may comprise a mixture of metal compounds, especially when exposed to an oxygen-containing atmosphere during use.

The metal is applied to the support in the form of a metal compound, normally by precipitation from or impregnation of a solution of a soluble metal compound, and it is then preferably reduced to its elemental form, optionally after a calcination step. The reduction of the metal compound may be incomplete and so these compounds, or their oxidised forms may also be present in the getter. For these reasons, normally not all of the metal in the getter is in elemental form, although the active form of the metal in a preferred form of the getter is elemental metal. In this form the metal surface area is preferably at least 5 m²g⁻¹ (of metal), more preferably greater than 10 m²g⁻¹ and especially greater than 20 m²g⁻¹. When the metal is nickel, the metal surface area is measured as described in “Physical and Chemical Aspects of Adsorbents and Catalysts”, edited by B. G. Linsen, Academic Press, 1970 London and New York, page 494 and 495, and is a measure of the surface area of the reduced, i.e. elemental nickel in the catalyst. The copper surface area is conveniently determined by the nitrous oxide decomposition method, for example as described by Evans et al in “Applied Catalysis”, 7, (1983), pages 75-83—a particularly suitable technique is described in EP 0 202 824. The cobalt surface area is determined by H₂ chemisorption using the method described in EP-A-0775018 and in the Operators Manual for the Micromeritics ASAP 2000 Chemi System V 1.00, Appendix C, (Part no 200-42808-01, 18^{th} Jan. 1991).

The getter is preferably in the form of a shaped pellet or tablet which is non-friable and resistant to breakage. The getter dimensions may vary according to the application for which it is to be used, but typically the largest dimension is between about 2 mm and 30 mm. The shape of the getter may be a circular, rectangular, triangular or other polygonal tablet, having a thickness of between about 0.5 and 5 mm. Other shapes designed to provide a relatively large surface for exposure to the atmosphere may also be used.

The support may be any suitable, preferably inert, solid material such as alumina, silica, silica-alumina, titania, zirconia, carbon, or a zeolite. Alumina is the preferred support material. In many applications, carbon, especially graphite, is not preferred because of its conductive properties which may affect the performance of electrical equipment. The support preferably has a pore volume of at least 0.1 cm³g⁻¹, more preferably greater than 0.2 cm³g⁻¹ and especially greater than 0.4 cm³g⁻¹. The support may be formed into the desired shape of the getter by tabletting or extrusion, for example, before the metal or metal compound is applied. Alternatively the metal compound may be applied to the support in the form of a powder or granule before shaping into the desired form.

A binder compound may be present in the getter to provide a strong tablet or extrudate. The binder is any suitable inorganic binder material. Preferred binders are non-porous silicas such as colloidal silica or fumed silica. The composition preferably contains up to 25% by weight of the binder.

Other compounds such as lubricants, colourants etc may also be present. Pelleting aids such a graphite or metal stearates may be included in the powder mixture, but since at the preferred calcination temperatures graphite may only be partially removed, stearates, especially magnesium stearate, are preferred pelleting aids.

To assist with the extrusion or granulation process, or indeed to assist in the preparation of a paste which is subsequently dried and milled before tabletting, certain organic components may be added. These organic components can be readily removed during any calcination stage (as described above) leaving no residual organic species. For the tabletting process convenient organic additives include polyvinyl alcohol or cellulose materials such as microcrystalline cellulose.

Tabletting (or compaction) is the preferred method of preparing the final form. This is because it provides a higher density formed body than other methods of forming such as extrusion or granulation and can give products having a close dimensional tolerance. The higher density allows a higher mass loading of getter into a housing of a certain volume or alternatively allows the same mass of getter to be enclosed in a smaller volume: this is an important consideration for electronic and opto-electronic devices where overall physical dimensions are an important feature. The close dimensional tolerance allows preparation of getters which may fit tightly into a certain housing or retaining unit and, most importantly, allows very thin getters (for example about 1 mm thickness) to be prepared. Alternatively the getter may be made by other shaping techniques such as roll compacting or paste extrusion followed as necessary by calcination to remove any extrusion aids etc.

The metal may be applied to the support material by precipitation onto the support, by coprecipitation with the support or by impregnation of the support with a solution of the metal compound. Precipitation and impregnation methods for metal compounds such as nickel, copper and cobalt are well known in the art of catalyst preparation. In a typical precipitation method, an aqueous solution of a soluble metal salt such as a copper, cobalt or nickel nitrate, sulphate, chloride etc is mixed with an alkaline precipitating agent such as an alkali metal carbonate, hydroxide or bicarbonate to effect precipitation of the insoluble cobalt, copper or nickel salt. The precipitation may be effected in the presence of particles of the solid support. The precipitated metal compound is preferably reduced in hydrogen to form elemental metal, optionally after calcination step.

Co-precipitation methods are equally well-known in the art and normally require that a solution of a soluble precursor of the support, such as a silicate or aluminate is present with the metal compound during the precipitation step. The silicate or aluminate may be pre-mixed with the solution of the soluble metal compound, but may also be added to the precipitant separately from the metal compound either prior to or simultaneously with the metal compound precipitation in order to maintain control over the pH of the solution during precipitation. All of these methods are well known. The co-precipitated metal compound is preferably reduced in hydrogen to form elemental metal, optionally after calcination step.

In a further method, the metal compound may be applied by impregnating the support material with a soluble compound of the metal, such as a metal salt, e.g. a nitrate, sulphate, chloride or a salt of an organic acid such as formic or acetic acid, and then drying. Impregnation methods are well known to the skilled person. In one common method the support is immersed in an excess of the solution for a period of time to enable the solution to be absorbed into the support, before being removed and then dried. Another common impregnation technique is the so-called “incipient wetness” technique in which a measured amount of a solution of the metal compound is added slowly, e.g. by spraying, to the support material. The volume of solution applied is normally calculated to fill a certain proportion of the pore-volume of the support. The impregnated metal compound is then preferably reduced in hydrogen to form elemental metal, optionally after calcination step.

As a further alternative the method described in GB 926235 to make hydrogenation catalysts may be used. In this method, a support material, such as silica or alumina, impregnated with a solution of a metal ammine carbonate complex is heated in air to decompose the ammine carbonate complex and thereby precipitate a basic metal carbonate on to the support particles. The metal is preferably nickel, cobalt or copper. The product is optionally calcined to convert the basic metal carbonate to metal oxide. The resulting metal oxide or basic metal carbonate may then be reduced to elemental metal.

The calcination step refers to heating the compound, normally in excess of 200° C., preferably between about 200 and about 600° C., e.g. from 250 to 450° C., in order to decompose a precipitated or impregnated metal compound to a more stable or more readily reducible form, e.g. to decompose a precipitated copper carbonate or hydroxycarbonate to copper oxide species. Calcination may be carried out in flowing or static air or other gas mixtures. Normally the material is calcined at elevated temperature for at least 3 hours, e.g. from 3 to 6 hours. Calcination methods are well known in the field of catalyst preparation and suitable conditions should be selected to provide a well-dispersed metal compound which can be reduced to an oxidisable metal or metal compound of high surface area. The calcination of a moulded tablet or pellet may also serve to remove organic compounds, added for example as an extrusion or tabletting aid, from the final product.

Reduction of the metal compound to elemental metal or to a metal compound of lower oxidation state than the unreduced metal compound is normally carried out by heating the prepared, supported metal compound normally in a stream of hydrogen, optionally diluted in nitrogen or other inert gas at a temperature between about 125° C. and 600° C., more usually between about 150 and 550° C., typically between about 200 and 450° C. The reduction step may be carried out following calcination or the calcination step may be omitted if the metal compound is deposited on the support in a form in which the metal may be reduced. Alternatively a salt may be used that generates the metal directly upon calcination e.g. nickel formate. Normally the metal compound is reduced after a calcination step.

When the getters contain finely distributed metals such as copper, nickel or cobalt, the resulting product may be pyrophoric and must be handled in conditions which avoid exposure to the air. These getters may be stored in sealed containers, preferably under inert atmospheres and transferred into their final position for use under controlled conditions to avoid fire. Alternatively they may be supplied in passivated form and re-activated by the end-user.

Getters in accordance with the present invention may be employed for a variety of applications including certain electrical, electronic and/or opto-electronic devices e.g. high power laser enclosures.

### EXAMPLE 1

### Preparation of Support

An alumina support was prepared by tabletting a pseudoboehmite alumina (SCC 150 available from SASOL) using a Fette™ P1200 tabletting machine using a 5.4 mm diameter die set. Pellets of various thicknesses were prepared. The resulting pseudoboehmite tablets were fired to a gamma alumina type phase by heat treating as follows:
(i) Room temperature (RT) to 110° C. (ramp in 2 hours)
(ii) Hold at 110° C. for 2 hours
(iii) 110 to 500° C. (ramp in 2 hours)
(iv) Hold at 500° C. for 1 hour
(v) Cool to RT

The pellets were observed to shrink by about 10% during this firing and this shrinkage has to be taken into account when making tablets of specific dimensions.

### EXAMPLE 2

### Impregnation with Nickel Compound

The tablets prepared in Example 1 were impregnated with a nickel hexammine solution made up from:
1 litre 33% ammonia solution (BDH Ltd)
250 g ammonium carbonate chip (Brotherton Chemicals)
300 g basic nickel carbonate ((Ni(OH)₂₋₂ₓ(CO₃)ₓ.yH₂O)) 48% Ni minimum (Shepherd Chemicals)

The ammonium carbonate chip was added to the 1 litre of ammonia in a 5-litre wide necked round bottomed flask fitted with a glass top. The mixture was stirred overnight until the chip dissolved. 50 g aliquots of the nickel carbonate were added with half an hour stirring in between. When dissolution was completed the nickel hexammine solution was filtered to remove any particulate and stored in an air tight container.

30 g of the tablets prepared in Example 1 were dipped in the prepared Ni hexammine solution for 2 mins with agitation. The solution was then removed under vacuum using a Buchner apparatus for 10 mins. The sample was then dried at 150° C. for 30 mins in a static oven (with periodic mixing of the sample to aid drying) After drying the material was calcined at 280° C. for 2 hrs in a static oven. This procedure was repeated twice.

### EXAMPLE 3

### Reduction of Ni/alumina Tablets

A quartz follow-through “U” tube was modified to incorporate an isolation tap on the exit arm and the inlet side was fitted with a sealing frit, which allows gas to flow through the tube when the tube is connected to the reduction-unit port and seals when the tube is removed. Plugs of quartz wool were used to locate the calcined impregnated alumina samples from Example 2, about 0.5 g (oxidic material), in the tube which was attached to the instrument The furnace was raised around the tube. A 20-30 cc/min flow of 100% hydrogen was established and the furnace heated up at 10° C./min to 425° C. and held at this temperature for 2 hrs. The furnace was cooled and lowered still with hydrogen flowing over the sample.

### EXAMPLE 4

### O₂ Gettering

A sample of the Ni/alumina O₂ getter as made in Examples 1-3 above, was exposed to O₂ at different pressures at 35° C., and the O₂ uptake measured. The results, in Table 1 show that the getters are capable of significant O₂ removal even at low O₂ pressures.

TABLE 1

| O₂ pressure | Total O₂ uptake |
|---|---|
| (mm Hg) | (cc/g STP) |
| 0.1 | 2.4 |
| 1.1 | 2.5 |
| 10.5 | 2.6 |

### EXAMPLE 5

### Co Based Getter

This example demonstrates the preparation of a cobalt based getter and its preparation by a conventional impregnation technique.

A solution of cobalt nitrate was prepared by dissolving 25.97 g of cobalt nitrate hexahydrate in demineralised water and making up to a total weight of 112.6 g (ie 25.97 g of cobalt nitrate hexahydrate and 86.6 g water). This solution was used to impregnate 100 g of gamma alumina (Puralox™ HP14/150; from Sasol). The solution was added to the powder in aliquots with mixing (ca. 1-2 minutes) between each addition. After the final addition the material was dried at 110° C. for 3 hours then calcined (shallow bed) in static air at 350° C. for 4 hours. This yielded a 5% w/w Co on alumina material (based on reduced weight of cobalt).

Oxygen up-take was measured using a Micromeritics ASAP 2010 Chemisorption unit. A portion (0.316 g) of the sample made in Example 5 was loaded into the instrument and subjected to the temperature, time, atmosphere cycle shown below. The Analysis task measures the total O₂ uptake by measuring the volumes of oxygen taken up at pressures of 100, 150, 200, 300, 400, 500, 600, 680, 760 mmHg. The “Total” volume vs. pressure data was analysed using linear regression and the intercept at zero pressure was quoted.

For this sample an oxygen uptake value of 1.6 cm³/g was obtained showing that this sample has a very high oxygen capacity at very low pressures of oxygen.

| Task | Task Name | Gas* | Temp(° C.) | Rate(° C./min) | Time(min) |
|---|---|---|---|---|---|
| 1 | Evacuation | — | 50 | 10 | 15 |
| 2 | Flow | He | 140 | 10 | 60 |
| 3 | Evac | — | 140 | 10 | 5 |
| 4 | Flow | H₂ | 425 | 3 | 360 |
| 5 | Evac | — | 450 | 10 | 120 |
| 6 | Evac | — | 35 | 10 | 30 |
| 7 | Leak Test** | — | 35 | 10 | — |
| 8 | Analysis | O₂ | 35 | 10 | — |

*Gases:- 99.999% H₂, 99.999% He, 99.999% O₂
**In Task 7 the leak rate is measured. An acceptable leak rate is less than or equal to 10 umHg/min.

### EXAMPLE 6

### Cu Based Getter

The impregnation method of Example of 5 was repeated but on this occasion 20.04 g of copper nitrate trihydrate (Cu(NO₃)₂.3H₂O) was used in a total solution weight of 113.1 g (ie 20.04 g of Cu(NO₃)₂.3H₂O and 93.06 g demineralised water). After drying (as Example 5) a portion of the material was calcined (shallow bed) in static air at 120° C. for 4 hours followed by 350° C. for 4 hours. This yielded a 5% w/w Cu on alumina material (based on reduced weight of copper).

Oxygen Uptake on the Copper Getter

The method was as Example 6 except that 0.353 g of sample was used and the following activation/analysis profile employed:

| Task | Task Name | Gas | Temp(° C.) | Rate(° C./min) | Time(min) |
|---|---|---|---|---|---|
| 1 | Evacuation | — | 50 | 10 | 15 |
| 2 | Flow | He | 140 | 10 | 60 |
| 3 | Evac | — | 140 | 10 | 5 |
| 4 | Flow | H2 | 400 | 3 | 120 |
| 5 | Evac | — | 400 | 10 | 120 |
| 6 | Evac | — | 35 | 10 | 30 |
| 7 | Leak Test | — | 35 | 10 | — |
| 8 | Analysis | O2 | 35 | 10 | — |

An oxygen uptake of 1.8 cm³/g was obtained (when extrapolated to zero pressure) showing that this sample has a very high oxygen capacity at very low pressures of oxygen

1. A getter for use in a sealed enclosure comprising a readily oxidisable metal or metal compound supported on a solid support, wherein, when said metal is in elemental form, the metal surface area is greater than 5 m²g⁻¹ of metal.

2. A getter according to claim 1, wherein the metal is selected from the group consisting of nickel, cobalt and copper or mixtures thereof.

3. A getter according to claim 1, wherein said metal is formed by reduction of a metal compound supported on said support.

4. A getter as claimed according to claim 1 in the form of a shaped pellet or tablet.

5. A getter according to claim 1, wherein the support is selected from the group consisting of alumina, silica, silica-alumina, titania, zirconia, carbon, or a zeolite.

6. A method of forming a shaped solid particle suitable for use as a getter for oxygen, said getter comprising a readily oxidisable metal or metal compound supported on a solid support, comprising the steps of:
(a) forming a shaped particle of solid support material,
(b) depositing a compound of said metal on said shaped particle of support material, by impregnation or precipitation techniques, and
(c) reducing at least a portion of said metal compound to elemental metal by heating said shaped support and metal compound in a gaseous stream containing hydrogen.

7. A method of forming a shaped solid particle suitable for use as a getter for oxygen, said getter comprising a readily oxidisable metal or metal compound supported on a solid support, comprising the steps of:
a) depositing a compound of said metal on the support material,
(i) by impregnation of precipitation, or
(ii) by forming an intimate mixture of support material and metal compound by co-precipitating the metal compound with the support material; then
(b) shaping the supported metal compound into a shaped solid particle by tabletting, pelleting or extrusion techniques, and
(c) reducing at least a portion of said metal compound to elemental metal by heating said shaped support and metal compound in a gaseous stream containing hydrogen.

8. An electrical, electronic or optoelectronic apparatus including a sealed enclosure containing a getter according to claim 1.

9. (canceled)

10. A getter for gettering oxygen in an electrical, electronic or optoelectronic apparatus, said getter comprising a shaped solid particle comprising a metal selected from the group consisting of copper, cobalt or nickel in elemental form supported on a solid support material selected from the group consisting of alumina, silica, silica-alumina, titania, zirconia, carbon or a zeolite.

11. A method according to claim 6 further comprising the step of, between steps b) and c), calcining said shaped metal support and metal compound.

12. A method according to claim 7 further comprising the step of, between steps a) and b), calcining said shaped metal support and metal compound.
